(19) United States
(12) Patent Application Publication
(10) Pub. No.: US 2017/0268700 A1
(43) Pub. Date: Sep. 21, 2017

(54) Self-Retracting Boom Pole Cable

(71) Applicant: Preferred Mart, Middletown, NY (US)

(72) Inventor: Yoel Farkas, Middletown, NY (US)

(21) Appl. No.: 15/070,407

(22) Filed: Mar. 15, 2016

(51) Int. Cl. F16L 3/01; F16M 13/00

(52) U.S. Cl. CPC F16L 3/012; F16M 13/005

(57) ABSTRACT

A retractable boom pole disclosed herein has a telescoping pole with hollow interior. A cable running at least substantially a length of the telescoping pole is centrally situated within the hollow interior at least substantially the entire length of the telescoping pole. A retraction mechanism (such as a spring-loaded or electrically powered motor device causing rotation of a spindle within the hollow interior) situated within a housing connected to the telescoping pole, causes the cable to be retracted as the telescoping pole is shortened in length. An electrical outlet or port situated within the housing is electrically coupled to the cable.

### FIELD OF THE DISCLOSED TECHNOLOGY

The disclosed technology relates generally to boom poles and, more specifically, to a boom pole with a self-retracting interior cable.

### BACKGROUND OF THE DISCLOSED TECHNOLOGY

Boom poles are long poles held on one side, with a device mounted or attached on the other side. They are often used in the television and film industry with microphones on a far end. Thus, one might hold the boom pole above the frame of view of a camera and receive the audio from a person speaking in front of the camera. The holder of the pole is also out of view of the camera, and the cable to the boom pole extends downward therefrom. In this manner, one can bring a microphone close to a person or sound-emanating object to obtain good sound quality without having the microphone on the person or in the camera view.

While the above method works well in many instances, it does have drawbacks. Namely, one may want to change the length of the boom pole such as with a telescoping arm being extended or retracted. The problem with doing so is a wire extending through the boom pole to the microphone at the other end tends to get caught, snagged, stretched, or struck. Some have placed coiled wires in the boom pole, but over time the coils lose their rigidity, and again the telescoping arm or wire gets caught, snagged, stretched, or stuck. Another problem is that the boom pole itself can create noise, such as rattling of coils or wires there-in, interfering with the clean audio (due to. For example, rattling noises) being recorded.

Therefore, there exists a need in the art for a way to extend a microphone and other equipment on a boom pole with electric cable, without the drawbacks of the prior art.

### SUMMARY OF THE DISCLOSED TECHNOLOGY

The disclosed technology is a boom pole (an extendable pole adapted for gripping on a first end, and use of an electricity-powered device on a second and opposite end). The pole has a telescoping shaft which, in turn, has a plurality of hollow sections that at least partially cascade each other. “Cascade” is defined as “an inner side of a first section covering an outer side of a second adjacent section.” A plurality of C-shaped supports within the plurality of hollow sections directs the path of a cable through the hollow sections. A retraction mechanism retracts the cable onto the spindle as the telescoping shaft shortens in length. The shaft can shorten in length such as by increasing the amount of cascading of the hollow sections. The spindle can be spring-loaded, in order to provide tension which reels the cable in as the length of the telescoping shaft is decreased.

A portal can be placed substantially at the first end. The cable can exit through this portal and be continuous from the portal through the telescoping arm (a form of a pole) and around the spindle. The cable can then further be continuous to an electrical connector situated between portions of the cable extending around the spindle. That is, an electrical connector can be placed in a central area which is surrounded by the spindle through which one can connect the cable to another electrical device. A microphone can be mounted, placed, or other attached to or by way of a cable at the first end and connect to another device via the electrical connector at the second end, where the spindle resides.

The cable is held at a center point of each hollow section of the plurality of hollow sections, in embodiments of the disclosed technology. The plurality of C-shaped supports are each of a different size corresponding to a hollow section of the plurality of hollow sections, in which each respective C-shaped support resides in some embodiments. Extension of the telescoping shaft causes the cable to unspool from the spindle, in some embodiments. A housing holds the spindle, the housing being fixedly connected to, or forming a unitary structure with, the telescoping shaft. in some embodiments.

Another way of describing embodiments of the disclosed technology is that a retractable boom pole has a telescoping pole with a hollow interior. A cable running at least substantially a length of the telescoping pole is centrally situated within the hollow interior at least substantially an entire length of the telescoping pole. A retraction mechanism (such as a spring-loaded or electrically powered motor device causing rotation of a spindle within the hollow interior), which is situated within a housing connected to the telescoping pole, causes the cable to be retracted as the telescoping pole is shortened in length. An electrical outlet or port, such as an XLR connector, which is situated within the housing, is electrically coupled to the cable.

The hollow interior in embodiments has a plurality of cable supports positioning the cable and causing the cable to be centrally situated. The plurality of cable supports has a widest circumference equal to that of the hollow interior of the telescoping pole, in embodiments of the technology. These cable supports can be C-shaped (having a central portal opening to the outside edge of the support), O-shaped (having a central portal only), or can assume any other shape. The supports can also be variously sized to fit differently-sized circular cross-sections of the telescoping arm.

For purposes of this disclosure, the term “substantially” is defined as “at least 95% of” the term which it modifies. Any device or aspect of the technology can “comprise” or “consist of” the item it modifies, whether explicitly written as such or otherwise. When the term “or” is used, it creates a group which has within either term being connected by the conjunction, as well as both terms being connected by the conjunction.

### BRIEF DESCRIPTION OF THE DRAWINGS

FIG. 1 shows a perspective view of a boom pole used in embodiments of the disclosed technology.

FIG. 2A shows a first side view of the boom pole used in embodiments of the disclosed technology.

FIG. 2B shows a second side view, turned 90 degrees compared to that of FIG. 2A, used in embodiments of the disclosed technology.

FIG. 2C shows a third side view, turned 180 degrees compared to that of FIG. 2A, used in embodiments of the disclosed technology.

FIG. 2D shows a cutaway view along section line A-A of FIG. 2B.

FIG. 3 shows a blown apart view of a handle region and cable with cable supports used in embodiments of the disclosed technology.

FIG. 4A shows a bottom plan view of a reel used in embodiments of the disclosed technology.

FIG. 4B shows a perspective view of the reel used in embodiments of the disclosed technology.

FIG. 4C shows a top plan view of the reel used in embodiments of the disclosed technology.

FIG. 4D shows a side view of the reel along section line B-B.

FIG. 4E shows a side cutaway view of the reel along section line B-B.

FIG. 5A shows a cutaway view of an O-shaped cable support used in embodiments of the disclosed technology, cut along section line C-C of FIG. 5B.

FIG. 5B shows a top view of an O-shaped cable support used in embodiments of the disclosed technology.

FIG. 5C shows a side view of an O-shaped cable support used in embodiments of the disclosed technology.

FIG. 6A shows a perspective view of a second O-shaped cable support used in embodiments of the disclosed technology.

FIG. 6B shows a side cutaway view of a second O-shaped cable support used in embodiments of the disclosed technology, cut along section line D-D of FIG. 6C.

FIG. 6C shows a top view of a second O-shaped cable support used in embodiments of the disclosed technology.

FIG. 7 shows a perspective view of a C-shaped cable support used in embodiments of the disclosed technology.

FIG. 8 shows various additional parts used in embodiments of the disclosed technology.

FIG. 9 shows a cutaway view of the interior of a telescoping arm/pole used in embodiments of the disclosed technology.

### DETAILED DESCRIPTION OF EMBODIMENTS OF THE DISCLOSED TECHNOLOGY

A retractable boom pole disclosed herein has a telescoping pole with hollow interior. A cable running at least substantially a length of the telescoping pole is centrally situated within the hollow interior at least substantially an entire length of the telescoping pole. A retraction mechanism (such as a spring-loaded or electrically powered motor device causing rotation of a spindle within the hollow interior) situated within a housing connected to the telescoping pole, causes the cable to be retracted as the telescoping pole is shortened in length. An electrical outlet or port, such as an XLR connector, situated within the housing is electrically coupled to the cable.

Embodiments of the disclosed technology will become clearer in view of the following description of the drawings.

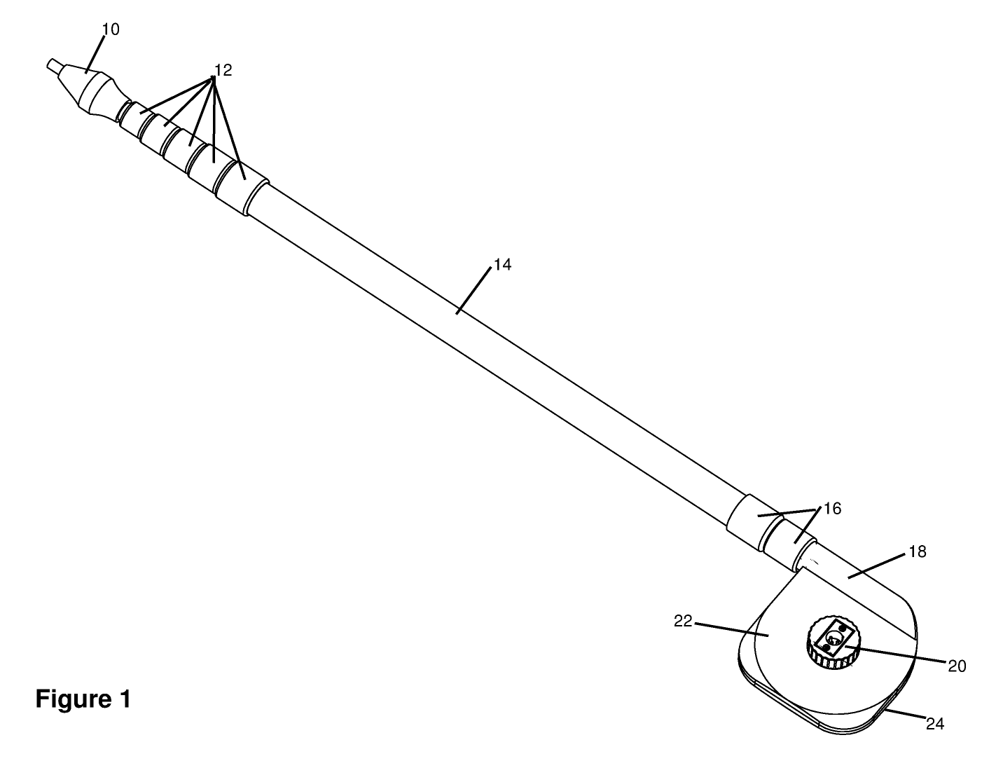

FIG. 1 shows a perspective view of a boom pole used in embodiments of the disclosed technology. A telescoping pole 14 has various hollow sections having ends 12 and 16 which, as shown in FIG. 1, are collapsed. Each section can have a circular cross-section and/or circumference and can be cascaded into (overlapped by) at least one other section. A first end 10 connects to a first of the hollow sections 12 of the telescoping pole 10, and can have a portal at the extreme tip, as shown; or otherwise, where a cable exits, or an electrical device, such as a microphone, is attached. The telescoping pole 14 attaches to a housing 18, and a reel or a spool 22, having a back side 24 and electrical connector or outlet 20, to which one can connect a cable. This electrical outlet 20 is electrically coupled to a cable or wire situated around the reel 22, and within the telescoping arm 14 and the hollow sections 12 and 16. In this manner, one can mechanically connect and electrically couple an electrical device, such as a microphone, to the first end 10 of the boom pole which is, in turn, powered by, and/or sending, electrical impulses through the electrical outlet 20.

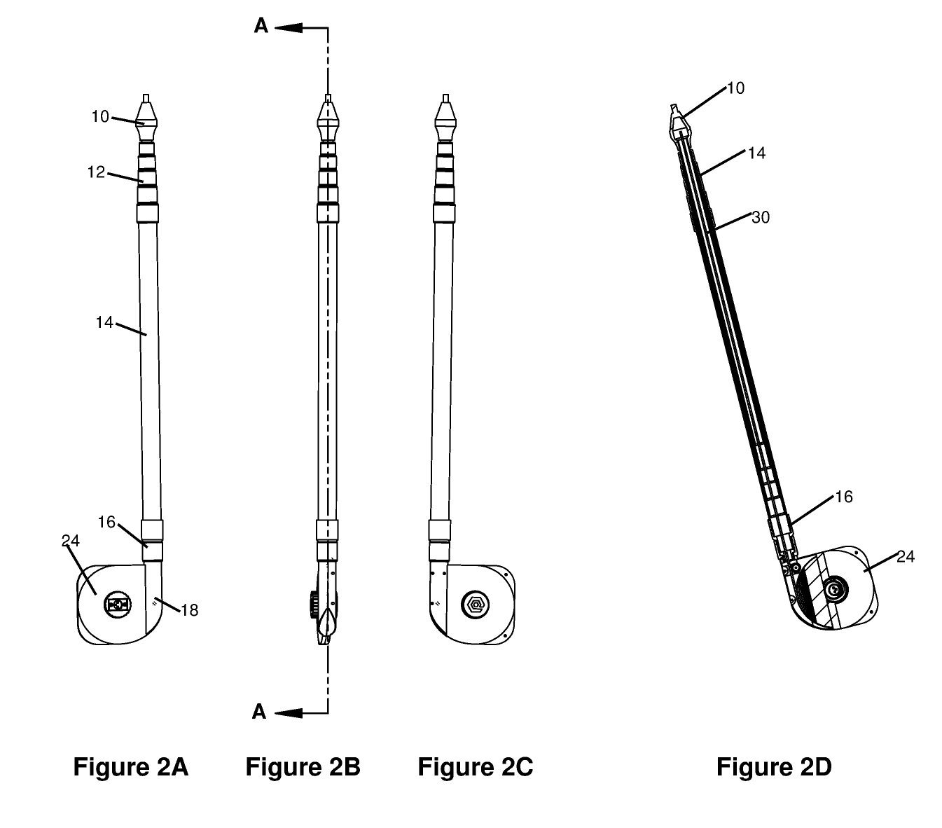

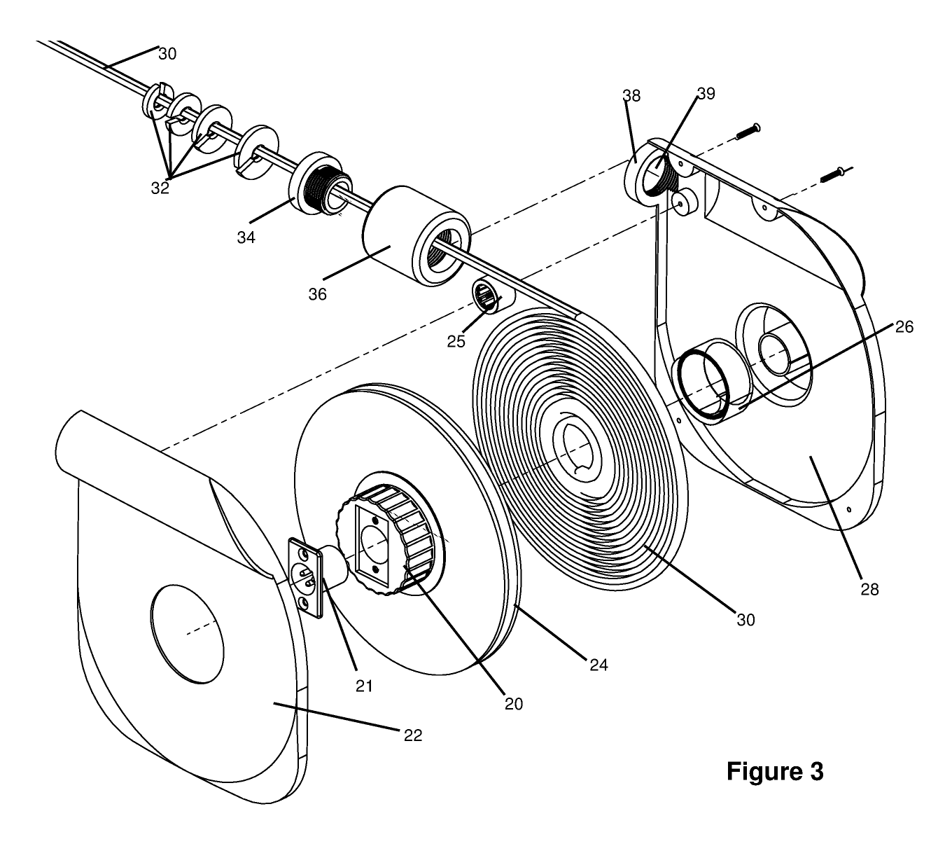

FIG. 2A shows a first side view of the boom pole used in embodiments of the disclosed technology. FIG. 2B shows a second side view, turned 90 degrees compared to that of FIG. 2A, used in embodiments of the disclosed technology. FIG. 2C shows a third side view, turned 180 degrees, compared to that of FIG. 2A, used in embodiments of the disclosed technology. FIG. 2D shows a cutaway view along section line A-A of FIG. 2B. Referring specifically to FIG. 2D, an electric cable 30 extends though the telescoping boom pole 14 on one end, and wraps around the reel or spool 24. This will become clearer in view of the following discussion of FIG. 3.

FIG. 3 shows a blown apart view of a handle region and cable with cable supports, used in embodiments of the disclosed technology. Here, the reel/spool 24 is shown top and bottom sides, having a space there-between where the cable 30 wraps there-in or there-between the spool 24 and a back side 28 of the housing. A spacer 26 is situated in a rotatable manner within the back side of the housing 28, on which the cable 30 rotates or can rotate there-about. A front side 22 of the housing is secured to the back side 28, such as by screws or other fasteners, holding a spool 24 therein. The cable 30 is thus rotatable around the spool and out of a portal 39, defined by a circular region 38 of the housing. An electrical outlet 21 stays in a stationary position within the housing and connected to an interior connector 20 on the surface of the housing. The electrical outlet 21 is connected via metal or other conductive material to an extreme end of the cable 30. Another flange 25 connects between the front and back sides of the housing. This flange 25 is a bearing the guides the cable to the spool.

Referring still to FIG. 3, the cable 30 exits through portal 39, which is defined by circular region 38. The circular region 38 fixedly or unitarily connects to the telescoping pole 14 (see FIG. 1). This can be accomplished through a nut 36 (O-shaped support) and second nut 34 (O-shaped support). The nut 34 can screw into threads of the housing 39. A plurality of C-shaped supports 32 is within hollow sections of the telescoping arm 14. Each one can be a different size and/or decrease its size from one to the next, in order. The sizes of these C-shaped supports correspond to the internal cross-sectional size of each hollow portion of the telescoping pole or arm 14, in embodiments of the disclosed technology.

Note the tension on the cable 30 keeping the cable straight. This is due to a winding mechanism of the spool 24. As the telescoping arm is decreased in length, winding mechanism of the spool 24 pulls the cord back around the spool, in order to keep the cable taut. The winding mechanism can be mechanical and based on the extension and contraction of a spring. The spring may require winding, in embodiments. In other embodiments, an electrical mechanism is used with a low-powered motor, in order to wind automatically as tension is relieved (due to contraction of the telescoping arm). Meanwhile, extension of the arm overcomes the retracting force, and the telescoping arm can be extended, pulling the cable off the spool while doing so.

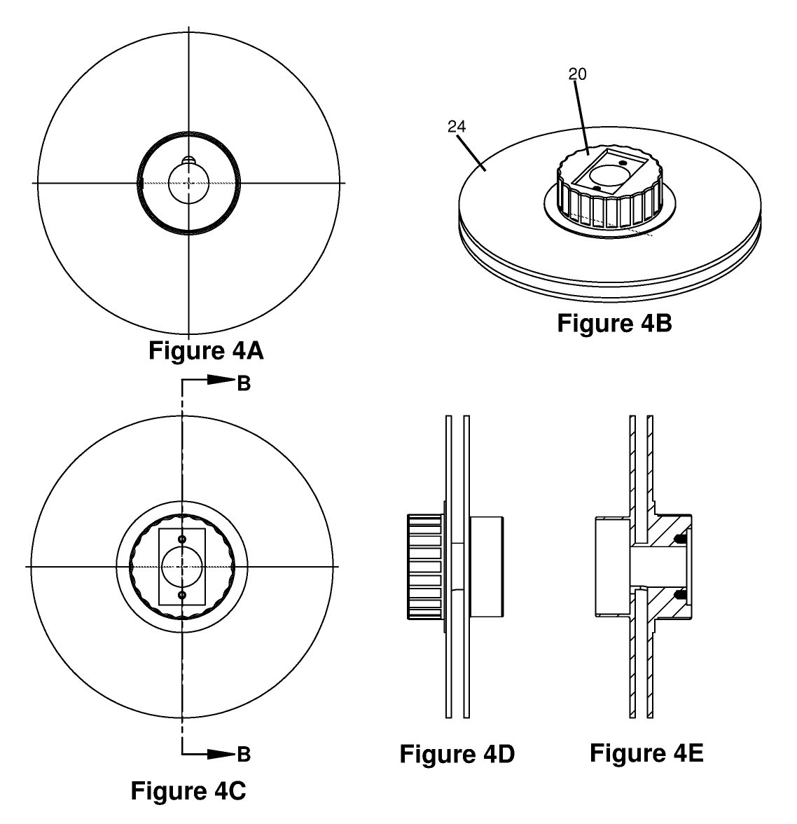

FIG. 4A shows a bottom plan view of a reel used in embodiments of the disclosed technology. FIG. 4B shows a perspective view of the reel used in embodiments of the disclosed technology. FIG. 4C shows a top plan view of the reel used in embodiments of the disclosed technology. FIG. 4D shows a side view of the reel along section line B-B. FIG. 4E shows a side cutaway view of the reel along section line B-B. The spool 24 is circular in embodiments and spins around or with a centrally located electrical outlet located at the center of the spool. The outlet remains electrically coupled (in contact metal to metal) with the cable 30 through the spool.

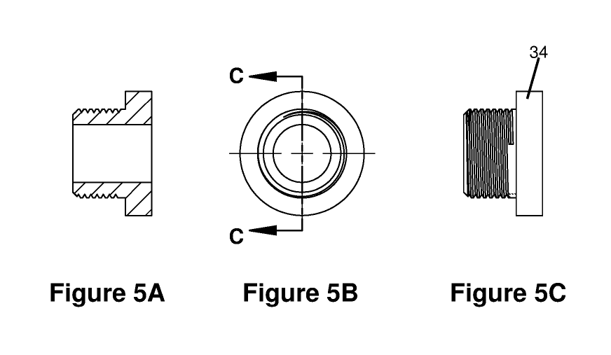

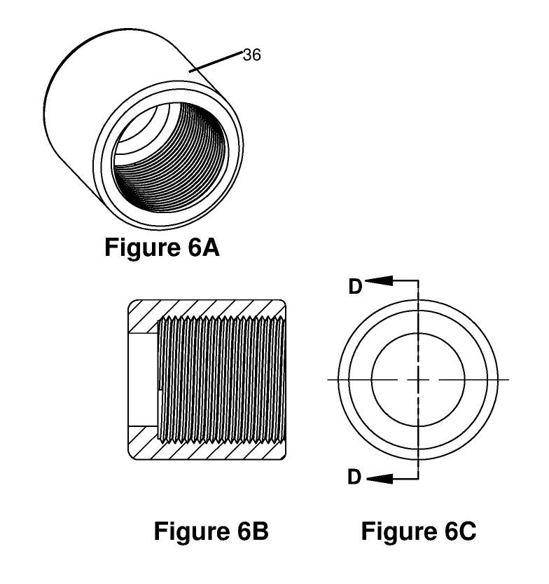

FIG. 5A shows a cutaway view of an O-shaped cable support used in embodiments of the disclosed technology, cut along section line C-C of FIG. 5B. FIG. 5B shows a top view of an O-shaped cable support used in embodiments of the disclosed technology. FIG. 5C shows a side view of an O-shaped cable support used in embodiments of the disclosed technology. FIG. 6A shows a perspective view of a second O-shaped cable support used in embodiments of the disclosed technology. FIG. 6B shows a side cutaway view of a second O-shaped cable support used in embodiments of the disclosed technology, cut along section line D-D of FIG. 6C. FIG. 6C shows a top view of a second O-shaped cable support used in embodiments of the disclosed technology. These cable supports 34 and 36 can also serve to connect the telescoping pole or arm 14 to the housing via their threaded interiors.

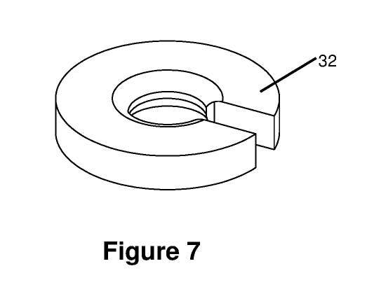

FIG. 7 shows a perspective view of a C-shaped cable support 32 used in embodiments of the disclosed technology. The C-shaped cable support has a circular interior and exterior, with a rectangular or trapezoidal cutaway area between the inner and outer sides forming the C-shape. In this manner, during construction of the boom pole, the cable 30 is slid into place within the boom pole. By varying the orientation of the cutaway area from one C-shaped cable support 32 to the next, the cable will not exit out of the middle of any one C-shaped cable support because it might then push against an inner edge of adjacent such supports.

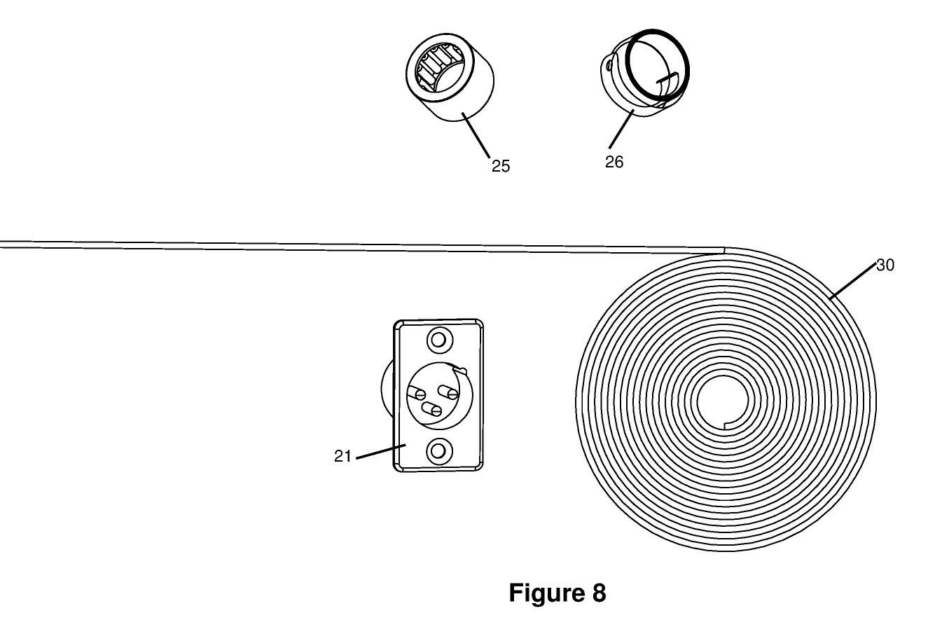

FIG. 8 shows various additional parts used in embodiments of the disclosed technology. Rings 25 and 26 are shown, in addition to being shown in FIG. 3. The cable 30 is shown as it is wrapped around a spool. The electric outlet 21 is shown, and can be an XLR port used with microphone cables.

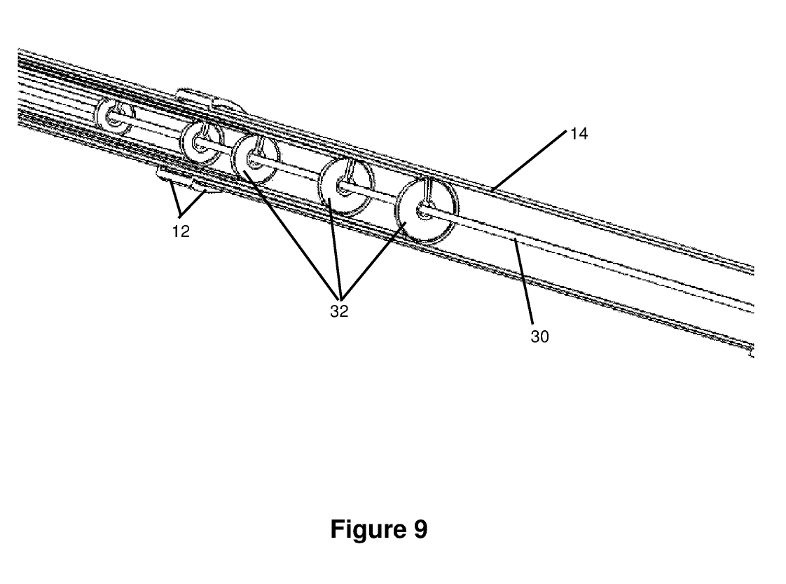

FIG. 9 shows a cutaway view of the interior of a telescoping arm/pole used in embodiments of the disclosed technology. There are a plurality of C-shaped supports guiding a wire or cable 30 along the length of the pole 14. Each telescoping section 12 is narrower or wider than another such telescoping section 12 of the pole which is adjacent there-to.

While the disclosed technology has been taught with specific reference to the above embodiments, a person having ordinary skill in the art will recognize that changes can be made in form and detail without departing from the spirit and the scope of the disclosed technology. The described embodiments are to be considered in all respects only as illustrative and not restrictive. All changes that come within the meaning and range of equivalency of the claims are to be embraced within their scope. Combinations of any of the methods and apparatuses described hereinabove are also contemplated and within the scope of the invention.

1. A boom pole with a first end and second end opposite said first end, comprising:
a telescoping shaft further comprising a plurality of hollow sections which at least partially cascade into each other;
a plurality of C-shaped supports within said plurality of hollow sections;
a cable extending through said plurality of hollow sections and said plurality of C-shaped supports;
a spindle which retracts said cable on to said spindle as said telescoping shaft shortens in length.

2. The boom pole of claim 1 further comprising a portal substantially at said first end through which said cable exits, said cable being continuous between said portal and around said spindle.

3. The boom pole of claim 2 further comprising an electrical connector situated between said cable extending around said spindle, which is electrically coupled to said cable.

4. The boom pole of claim 1, wherein said cable is held at a center point of each hollow section of said plurality of hollow sections.

5. The boom pole of claim 4, wherein said plurality of C-shaped supports are each of a different size corresponding to a hollow section of said plurality of hollow sections in which each respective C-shaped supports resides.

6. The boom pole of claim 1, wherein extension of said telescoping shaft causes said cable to unspool from said spindle.

7. The boom pole of claim 1, wherein said spindle is within a housing which is fixedly connected to said telescoping shaft.

8. A retractable boom pole comprising:
a telescoping pole with hollow interior;
a cable running at least substantially a length of said telescoping pole centrally situated within said hollow interior at least substantially an entire length of said telescoping pole;
a retraction mechanism, situated within a housing connected to said telescoping pole causing said cable to be retracted as said telescoping pole is shortened in length;
an electrical outlet situated within said housing electrically coupled to said cable.

9. The retractable boom pole of claim 8, wherein said hollow interior comprises a plurality of cable supports, causing said cable to be centrally situated.

10. The retractable boom pole of claim of claim 9, wherein said plurality of cable supports has a widest circumference equal to that of said hollow interior of said telescoping pole.

11. The retractable boom pole of claim 10, wherein said cable supports are C-shaped.

12. The retractable boom pole of claim 10, wherein said cable supports are O-shaped.

13. The retractable boom pole of claim 8, wherein said telescoping pole comprises different sections, each with a differently-sized circular cross-section.

14. The retractable boom pole of claim 8, further comprising a portal at an end of said telescoping pole, opposite said housing, through which said cable exits.
